(19) United States
(12) Patent Application Publication
(10) Pub. No.: US 2012/0056360 A1
(43) Pub. Date: Mar. 8, 2012

(54) Process for producing metal composite material

(75) Inventors: Makoto Fujita, Aichi (JP); Koji Maruyama, Aichi (JP); Ikuo Suzuki, Aichi (JP)

(73) Assignee: Central Motor Wheel Co., Ltd., Aichi (JP)

(21) Appl. No.: 13/199,747

(22) Filed: Sep. 8, 2011

(30) Foreign Application Priority Data
Sep. 8, 2010 (JP) 2010-200443

(51) Int. Cl. C04B 35/10

(52) U.S. Cl. 264/642

(57) ABSTRACT

Producing a metal composite material by mixing hydrated ceramic particles, having water of crystallization that is bound within fine pores which have an average pore diameter of 1 nm or more and 80 nm or less, with a reinforcing material, the resulting mixture being sintered to form a preform which is then impregnated with a melt of an aluminum alloy and subjected to surface polishing. The ceramic particles, from which water of crystallization has been removed while the average pore diameter of the pores thereof is maintained, are dispersed uniformly, it is possible to obtain the metal composite material in which the ceramic particles that have fine pores are exposed on surfaces evenly in a stable manner by surface polishing that is conducted after the melt impregnation. The metal composite material can permit infiltration of a lubricating oil into the fine pores.

### CROSS-REFERENCE TO PRIOR APPLICATIONS

Priority is claimed to Japanese Patent Application No. 2010-200443, filed on Sep. 8, 2010, which is hereby incorporated by reference in its entirety herein.

### FIELD OF THE INVENTION

The present invention relates to a process for producing a metal composite material in which a metal base material such as an aluminum alloy and a reinforcing material are composited.

### BACKGROUND

In order to improve fuel efficiency and driving stability of, for example, automobiles, there is a tendency to increasingly use parts that are made of a light metal such as aluminum alloy which is excellent in light weight, durability, thermal expansion, etc. In particular, a metal composite material in which a light metal such as an aluminum alloy is composited with a reinforcing material such as a ceramic fiber is being applied, because of its inherent properties of the light metal and its excellent wear resistance, to so called sliding members, such as a cylinder and a piston, which are to constitute engines. Such a metal composite material may be generally produced by forming a preform that has a predetermined shape by using a reinforcing material such as ceramic short fibers and ceramic particles, the obtained preform being thereafter impregnated with a melt of a light metal under pressure by, for example, a die casting method.

For use as a sliding member, such as a cylinder, which requires wear resistance in order to sufficiently withstand high speed reciprocating operation, it is generally well known to employ a constitution in which ceramic particles, such as of graphite and activated carbon, that have self-sliding property are contained. Specifically, with a view toward improving the wear resistance, employed is a constitution in which ceramic particles, such as of graphite, are exposed on a sliding surface that is to face a counterpart material for sliding relative thereto. Because the metal base material (such as an aluminum alloy) is also exposed on the sliding surface, a predetermined lubricating oil is used in order to prevent occurrence of seizing between the metal base material and the counterpart material which is to slide relative thereto at the sliding surface. The lubricating oil can protect the sliding surface and prevent the metal base material from being brought into direct contact with the counterpart material which is to slide relative thereto. Therefore, the desired wear resistance can be maintained for a long period of time.

Also, the present inventors proposed in the past a metal composite material that has a constitution in which porous aluminum borate particles are exposed on a surface thereof (Japanese Unexamined Patent Publication No. JP-A-2008-19484). When the metal composite material is used as the above-described sliding member, a lubricating oil can be retained in the pores of the aluminum borate particles that are exposed on its surface (sliding surface) and can ooze out of the pores during sliding movement thereof. Therefore, the sliding member can maintain its wear resistance for a long period of time and can exhibit improved sliding life. In this case, in order to obtain the constitution in which the aluminum borate particles are exposed on the sliding surface, it is necessary to prevent infiltration of a melt of a metal base material into the pores of the aluminum borate particles during the impregnation step for the melt of the metal base material. Thus, aluminum borate particles are mixed, in water, with a silica sol that contains negatively charged silica particles and an alumina sol that contains positively charged alumina particles to flocculate the electrically neutralized silica particles and alumina particles on surfaces of the aluminum borate particles and to cover the surfaces of the aluminum borate particles therewith in a preform forming step. By this expedience, when the preform is impregnated with a melt, the melt is prevented from infiltrating into the pores of the aluminum borate particles. Thereafter, the surface (sliding surface) is polished to expose the aluminum borate particles that retain their porous state.

The process proposed in JP-A-2008-19484 attempts to prevent infiltration of a melt of the metal base material into the pores of aluminum borate particles by allowing silica particles and alumina particles to flocculate on surfaces thereof. It is, however, difficult to uniformly cover surfaces of all of the aluminum borate particles. Therefore, variation is apt to occur in the effect of maintaining the porous state of the aluminum borate particles. As a consequence, there exists a limitation in the effect of retaining a lubricating oil in the pores of the aluminum borate particles. Incidentally, it is necessary to use a large amount of silica sol and alumina sol in order to completely cover the aluminum borate particles. In this case, however, it is feared that the air permeability of the preform is adversely affected.

In view of the foregoing, it is an object of the present invention to provide a process that can produce a metal composite material which has excellent lubricating oil retaining property when applied to a cylinder of an engine, etc. and which shows desired sliding life in a stable manner.

### SUMMARY OF THE INVENTION

A metal composite material that is prepared by the metal composite producing process of the present invention, which is described hereinafter, includes a metal base material, and ceramic particles which have fine pores with an average pore diameter of 1 nm or more and 80 nm or less and which are dispersed in the metal base material, wherein the metal composite material has a surface on which the ceramic particles whose fine pores are retained are exposed. Here, it is preferred that the ceramic particles have fine pores with an average pore diameter of 1 nm or more and 40 nm or less.

The present inventors have made an earnest study on a method for preventing infiltration of a melt into ceramic particles and have found that the melt is unable to infiltrate into extremely fine pores thereof. Upon further study on a relationship between the infiltration of a melt and pore diameter, it has been found that the melt is unable to infiltrate into fine pores with a pore diameter of 40 nm or less. Namely, when a preform that is prepared by using ceramic particles that have fine pores with an average pore diameter of 40 nm or less is impregnated with a metal melt, the metal melt does not infiltrate into fine pores of the ceramic particles so that the fine pores are maintained as such. For this reason, the metal composite material of the present invention can be formed without need of a special measure for preventing infiltration of a melt into the pores such as covering of the ceramic particles which is adopted in the above-described conventional method. Further, as a result of a study on the pore diameter of the fine pores, it has been found that the melt may not be easily infiltrate and is prevented from infiltrating into fine pores when the pore diameter is 80 nm or less.

Upon detailed study on infiltration and retainment of a lubricating oil in ceramic particles, it has been confirmed that the lubricating oil is unable to infiltrate into pores with a diameter of less than 1 nm. And it has been found that the lubricating oil can infiltrate and can be retained in pores having an average pore diameter of 1 nm or more.

The production process of the present invention that is described hereinafter has been completed on the basis of the above findings. Since ceramic particles that have fine pores with an average pore diameter of 1 nm or more and 80 nm or less are exposed on a surface of the metal composite material with their pores maintained as such, a lubricating oil can infiltrate into the fine pores of the ceramic particles that are exposed on the surface and can be retained therein. Further, since the fine pores of the ceramic particles are surely and stably maintained, the amount of the lubricating oil that is retained in the ceramic particles that are exposed on the surface is stabilized. The effect of infiltration and retainment of the lubricating oil is more surely and stably achieved when the ceramic particles have fine pores with an average pore diameter of is 1 nm or more and 40 nm or less.

When the metal composite material that is formed by the hereinafter described process is used as the aforementioned sliding member such as a cylinder and even when a sliding movement is repeated for a long period of time, surface wear thereof may be suppressed by a lubricating oil that oozes from the fine pores of the ceramic particles that are exposed on the surface. Thus, the sliding life can be significantly improved. More specifically, as the sliding movement between the sliding member and a counterpart material that is to slide relative thereto is repeated for a long period of time, the lubricating oil gradually deteriorates. However, since the lubricating oil held in the fine pores of the ceramic particles that are exposed on the surface can oozes therefrom as replenishment, the desired wear resistance can be maintained so that the sliding life can be improved.

When the sliding member is constituted of the metal composite material that is formed by the process above, the above-described operation and effect can be achieved as long as the ceramic particles having the fine pores are exposed on at least a specific surface that serves as a sliding surface.

In general, fine pores of ceramic particles have various pore diameters or various pore shapes. Such variation of the pore diameter or various pore shapes may be involved in the fine pores that are specified in terms of the average pore diameter in the present invention. The constitution that employs the ceramic particles which have such specific fine pores can achieve the above-mentioned effects. In view of the fact that ceramic particles that have such an extremely small average pore diameter are not generally positively used, use of such ceramic particles is of great significance.

It is preferred that the ceramic particles used in the present examples have pores with a pore volume of 0.1 cc/g or more as measured by a gas adsorption method. The pore volume is the sum of inside volumes of the fine pores of the ceramic particles. Therefore, the amount of a lubricating oil that can be retained in the fine pores of the ceramic particles depends on the pore volume. Namely, the smaller the pore volume, the smaller is the amount of the lubricating oil that is to be retained therein. Thus, when the composite material is used as a sliding member, it is preferred that the pore volume is 0.1 cc/g or more in order to improve the sliding life thereof while maintaining desired wear resistance. With regard to the upper limit of the pore volume, on the other hand, the pore volume is suitably 1.0 cc/g or less in consideration of the average pore diameter of the fine pores.

Ceramic particles that have fine pores with an average pore diameter of 2 nm or more are more suitably used, since a lubricating oil can more easily infiltrate into the fine pores and can be held there in more stably. Ceramic particles that have fine pores with an average pore diameter of 30 nm or less are more suitably used. Accordingly the effect of preventing infiltration of a melt is more improved.

Ceramic fibers such as alumina fibers and whiskers may be used as a reinforcing material. Further, examples may be constituted such that ceramic particles that do not fall within the scope of the above-described porous ceramic particles which have fine pores with the specific average diameter are used as the reinforcing material.

The ceramic particles of the metal composite material that is prepared by the hereinafter described metal composite producing process of the present invention are formed in such a manner that hydrated ceramic particles, that have water of crystallization which is bound within fine pores thereof are heated at a predetermined temperature to remove the water of crystallization in the fine pores.

The hydrated ceramic particles that have water of crystallization which is bound within fine pores thereof are converted into porous ceramic particles that have pores with an average pore diameter of 1 nm or more and 80 nm or less, by removing the water of crystallization that is bound within the fine pores. As the hydrated ceramic particles, there may be suitably used those which have pores that have an average pore diameter of 1 nm or more and 80 nm or less and bind water of crystallization and which can maintain the average pore diameter after having been heated at the predetermined temperature.

One proposed constitution of the metal composite material that is prepared by the hereinafter-described metal composite producing process is such that the ceramic particles are aluminum hydroxide oxide particles. Since the aluminum hydroxide oxide particles have fine pores with an average pore diameter of 1 nm or more and 40 nm or less, the above-described effect of the present invention can be properly achieved.

The process for producing such a metal composite material is characterized in that a preform, in which ceramic particles that have pores with an average pore diameter of 1 nm or more and 80 nm or less and a predetermined reinforcing material are present in a mixed state, is formed by sintering at a predetermined sintering temperature and is then impregnated with a melt of an aluminum alloy under pressure, and in that a predetermined surface of the obtained product is polished to expose, on the surface, ceramic particles that have maintained their fine pores and to obtain the metal composite material. The production process preferably uses ceramic particles that have fine pores with an average pore diameter of 1 nm or more and 40 nm or less.

According to the above production process in which ceramic particles that have pores with an average pore diameter of 1 nm or more and 80 nm or less are used, it is possible to obtain a metal composite material in which ceramic particles that have fine pores retained therein are exposed on a surface thereof. Here, since fine pores of the ceramic particles that are dispersed in the metal composite material are not clogged, fine pores of the ceramic particles that are exposed on the surface by polishing are open. Because the ceramic particles are exposed on the surface, the amount of the lubricating oil that can be retained on the surface of the metal composite material is stabilized. Therefore, the present production method can surely and stably produce a metal composite material that is capable of stably exerting the aforementioned operation and effect. When the process uses ceramic particles that have pores with an average pore diameter of 1 nm or more and 40 nm or less, the obtained metal composite material can more stably and surely exert the above-described effects of preventing infiltration of the melt and holding the lubricating oil.

Further, the production process uses ceramic particles that have pores with an average pore diameter of 1 nm or more and 80 nm or less for the formation of a preform and allows for maintaining the fine pores of the ceramic particles. Therefore, the production process may be relatively easily applied to various preform forming methods and to methods for producing metal composite materials with use of the preforms. Additionally, since the production process does not require means for covering ceramic particles that is employed in the above-described conventional method, it is possible to maintain the fine pores of the ceramic particles in a stable manner. For the above reasons, the production process can produce, in a stable manner, a metal composite material that can exert the above-described effect of improving the sliding life thereof.

The present examples provide a process for producing a metal composite material, which include a mixing step that mixes, in water, hydrated ceramic particles, that have water of crystallization which is bound within fine pores thereof that have an average pore diameter of 1 nm or more and 80 nm or less, with a reinforcing material to prepare an aqueous mixture liquid; a dewatering step that removes water from the aqueous mixture liquid to form a preliminary mixture body; a sintering step that sinters the preliminary mixture body to form a preform in which the ceramic particles and the reinforcing material are present in a mixed state; a melt impregnation step that impregnates the preform with a melt of an aluminum alloy under pressure to form a composite material; and a polishing step that polishes a predetermined surface of the composite material that has been formed in the melt impregnation step. Here, the production process in which ceramic particles that have fine pores with an average pore diameter of 1 nm or more and 40 nm or less are used is preferred for reasons that the above-described effects of preventing infiltration of the melt and retaining a lubricating oil are more surely and stably achieved.

In the above production process, by sintering the preliminary mixture body, in which hydrated ceramic particles that have fine pores within which water of crystallization is bound have been mixed, at a predetermined sintering temperature, the water of crystallization of the hydrated ceramic particles is removed. By this, it is possible to form a preform in which the ceramic particles, whose fine pores have an average pore diameter that is maintained unchanged, are dispersed. From the preform, the metal composite material that has a surface on which the ceramic particles are exposed may be obtained in a stable manner. This is attributed to the fact that because, in the mixing step, an aqueous mixture liquid in which the hydrated ceramic particles and the reinforcing material are mixed is prepared, the hydrated ceramic particles and the reinforcing material are easily uniformly dispersed. As a consequence, the preform in which the hydrated ceramic particles and the reinforcing material are present in a uniformly mixed state can be formed in a stable manner in the succeeding sintering step. Thus, it is possible to produce a metal composite material which can exert, in a more stable manner, the above-described effect that a lubricating oil can be stably and surely held.

Incidentally, the sintering step is intended to simultaneously perform both the removal of the water of crystallization of the hydrated ceramic particles while maintaining the average particle diameter of the fine pores and the sintering of the reinforcing material.

In the above-described process for producing the metal composite material, the mixing step may be carried out in such a manner that either one of an alumina sol or a silica sol is mixed as an inorganic binder to form the aqueous mixture liquid.

In such a production process, the ceramic particles and the reinforcing material are bound by being admixed with either one of an alumina sol or a silica sol, so that the preliminary mixture body can be formed into and held in a predetermined shape. Therefore, a preform of a desired shape may be easily formed in a stable manner in the sintering step. In such a production process, since the alumina sol and silica sol are used as an inorganic binder, it is sufficient that either one of them be used. Namely, it is not necessary to mix an alumina sol with a silica sol for neutralization thereof as is done in the above-described conventional process. Nor is it necessary to cover the ceramic particles with them.

Further, the alumina sol or silica sol is used in an amount that is sufficient to achieve performance as an inorganic binder. Therefore, it is possible to fully suppress a decrease of space between the ceramic particles and the reinforcing material. This gives an advantage that a preform that has high gas permeability can be easily obtained. Thus, the impregnability of a melt into the preform in the melt impregnation step is improved so that the formation of cavities (unimpregnated regions) is suppressed. Accordingly, it is possible to stably produce metal composite materials that can fully exert the desired mechanical properties.

The present examples also provide a process for producing a metal composite material as recited above, in which the ceramic particles are aluminum hydroxide oxide particles. Since the aluminum hydroxide oxide particles have fine pores with an average pore diameter of 1 nm or more and 40 nm or less, the above-described operation and effect of the present invention can be properly achieved. Incidentally, in the above mixing step, hydrated aluminum hydroxide oxide particles that contain water of crystallization that is bound within the fine pores are used.

Proposed here is a production process in which the sintering temperature is 1,100° C. or more and 1,250° C. or less. When particles of hydrated aluminum hydroxide oxide are heated at a temperature higher than 1,250° C., the water of crystallization thereof is removed. However, the particles cause a change in shape so that it becomes difficult for the fine pores thereof to retain an average pore diameter of 1 nm or more after the water of crystallization has been removed. Thus, the preform is formed at a sintering temperature of 1,250° C. or less in order to prevent such a shape change and to retain the average pore diameter of 1 nm or more and 80 nm or less. When the sintering temperature is excessively low, on the other hand, the reinforcing material fails to be sufficiently sintered and, moreover, the stability of the crystal water removal function tends to be lowered. Thus, the sintering temperature is 1,100° C. or more so that the reinforcing material can be sufficiently sintered and water of crystallization is sufficiently removed from the particles of hydrated aluminum hydroxide oxide. By performing the sintering at a sintering temperature of 1,100° C. or more and 1,250° C. or less, it is possible to produce the metal composite material of the present examples in a more stable manner.

The metal composite material that is prepared by the metal composite producing process of the present examples include a metal base material, and ceramic particles which have fine pores with an average pore diameter of 1 nm or more and 80 nm or less and which are dispersed in the metal base material, wherein the metal composite material has a surface on which the ceramic particles whose fine pores are retained are exposed. Therefore, a lubricating oil can infiltrate into the fine pores of the ceramic particles that are exposed on the surface and can be retained therein. Further, the amount of the lubricating oil that is held in the ceramic particles is stabilized. Thus, a sliding member such as a cylinder that is constituted of the metal composite material of the present invention exhibits a prolonged sliding life in a stable manner, since surface wear may be suppressed by a lubricating oil that oozes from the fine pores of the ceramic particles that are exposed on the surface. When the ceramic particles have fine pores with an average pore diameter of is 1 nm or more and 40 nm or less, the effect of retainment of fine pores is more surely and stably achieved so that the above-described operation and effect are much more improved.

When the ceramic particles of the metal composite material are those which have been obtained by removing water of crystallization that is bound within fine pores thereof by being heated at a predetermined temperature, it is possible to easily and stably obtain the metal composite material in which the ceramic particles have pores with an average pore diameter of 1 nm or more and 80 nm or less. Therefore, the metal composite material that has such ceramic particles can exert the above-described operation and effect in more stable and appropriate manner.

In the metal composite material, when the ceramic particles are aluminum hydroxide oxide particles, the above-described operation and effect can be properly achieved because the aluminum hydroxide oxide particles have fine pores with an average pore diameter of 1 nm or more and 40 nm or less.

The process for producing such a metal composite material is such that a preform, in which ceramic particles that have pores with an average pore diameter of 1 nm or more and 80 nm or less and a predetermined reinforcing material are present in a mixed state, is formed by sintering at a predetermined sintering temperature and is impregnated with a melt of a metal under pressure, the obtained product being thereafter polished to expose, on a predetermined surface, ceramic particles that have retained their fine pores. Therefore, the metal composite material that can exert the above effects can be stably produced. When the production process uses ceramic particles that have fine pores with an average pore diameter of 1 nm or more and 40 nm or less, the effect of preventing infiltration of the melt into the fine pores can be achieved in more surely and stably, and the effects of the present invention can be more improved.

When the metal composite material production process includes forming a preliminary mixture body from an aqueous mixture liquid, in which ceramic particles that have pores with an average pore diameter of 1 nm or more and 80 nm or less and a predetermined reinforcing material are mixed, sintering the preliminary mixture body at a predetermined sintering temperature to form a preform in which the ceramic particles and the reinforcing material are present in a mixed state, impregnating the preform with a melt of a metal, and polishing a surface of the obtained product, it is possible to obtain in a stable manner a metal composite material in which ceramic particles that retain the fine pores are uniformly dispersed, because the preform in which ceramic particles that have fine pores are uniformly dispersed is impregnated with the aluminum alloy melt. Since the thus produced metal composite material has a surface on which the ceramic particles that have fine pores are stably and evenly exposed, the production process of the present invention can produce, in a more stable manner, a metal composite materials that is capable of exerting, in a stable manner, the effect of improving sliding life thereof. Here, when the production process uses ceramic particles that have fine pores with an average pore diameter of 1 nm or more and 40 nm or less, the effect of preventing infiltration of the melt into the fine pores can be achieved in more surely and stably, and the operation and effect of the present examples can be more improved.

In the metal composite material production process, when the ceramic particles that are used are aluminum hydroxide oxide particles, the stability of producing the metal composite material is further improved, because the aluminum hydroxide oxide particles have fine pores with an average pore diameter of 1 nm or more and 40 nm or less.

Here, when the production process employs a sintering temperature of 1,100° C. or more and 1,250° C. or less, it is possible to produce the metal composite material in a more stable manner, since the aluminum hydroxide oxide particles can be maintained in a desired structure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1(A) to 1(C) illustrate views that are explanatory of a preform forming step of one example of the process of the present invention.

FIGS. 2(A) and 2(B) illustrate views that are explanatory of a melt impregnation step in which a die casting device is used.

FIGS. 3(A) and 3(B) illustrate views that are explanatory of a melt impregnation step which succeeds FIGS. 2(A) and 2(B).

FIG. 4 shows a magnification photograph of aluminum hydroxide oxide particles.

FIGS. 5(A) through 5(D) show magnification photographs of metal composite materials of Examples 1 to 4 each in color checking state.

FIG. 6 is a chart showing the results of oil retaining property measurement for metal composite materials of Examples 1 to 4 and Comparative Examples 1 and 2.

### DETAILED DESCRIPTION OF THE INVENTION

Examples of the present invention are described in detail with reference to the accompanying drawings.

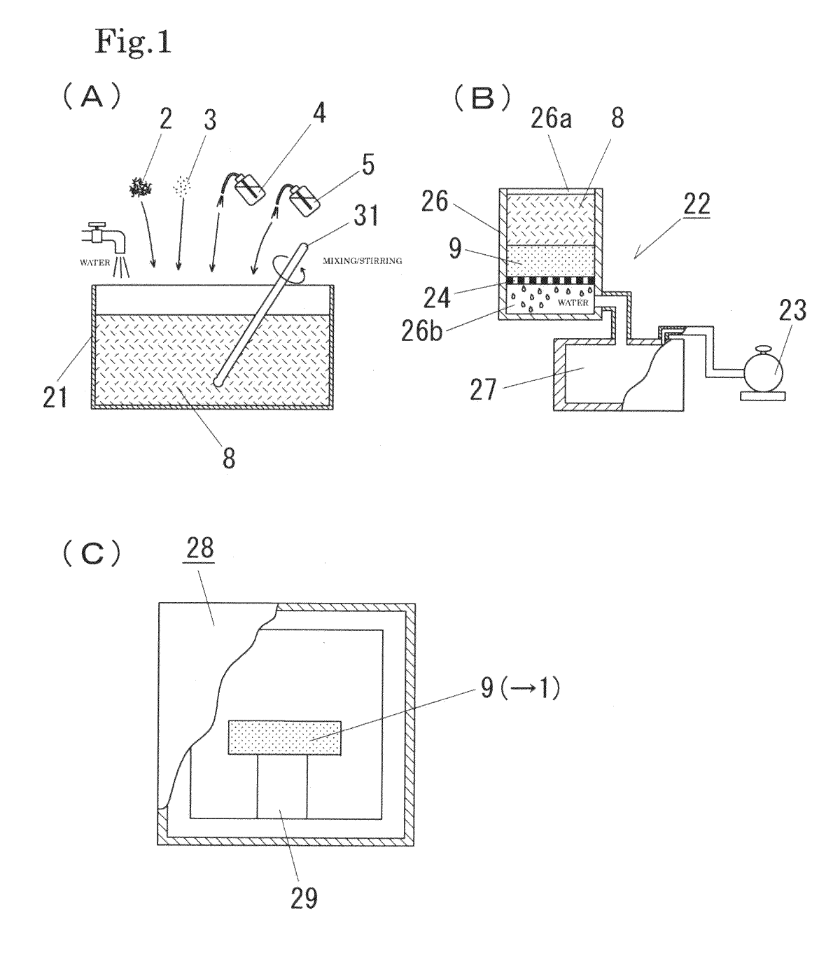

FIG. 1 depicts views that illustrate steps for forming a preform 1. The preform forming step includes a mixing step (see FIG. 1(A)), a dewatering step (see FIG. 1(B)), a drying step (not shown) and a sintering step (see FIG. 1(C)). These steps are successively performed to obtain the desired preform 1.

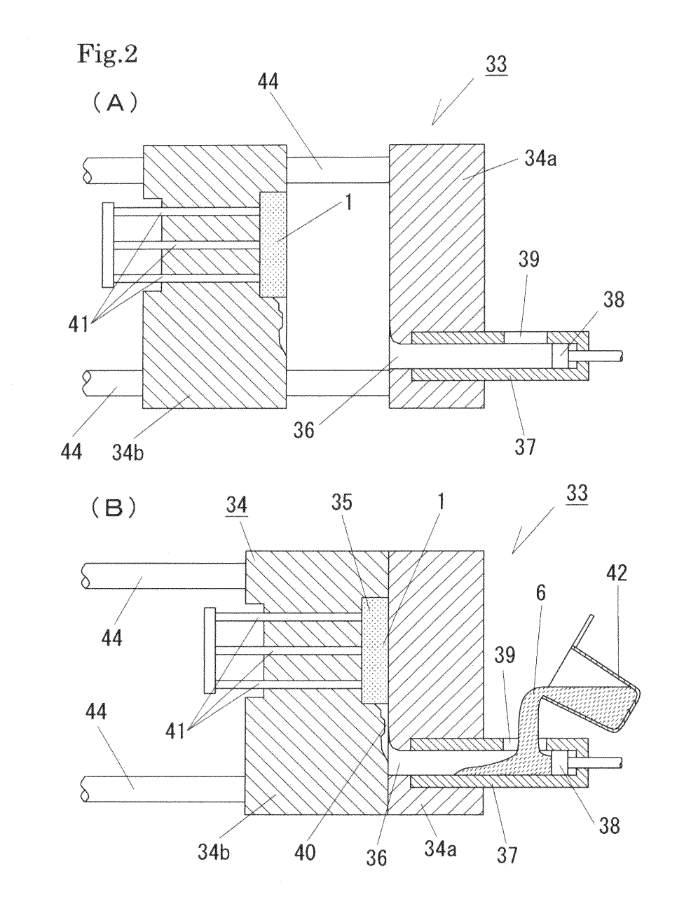

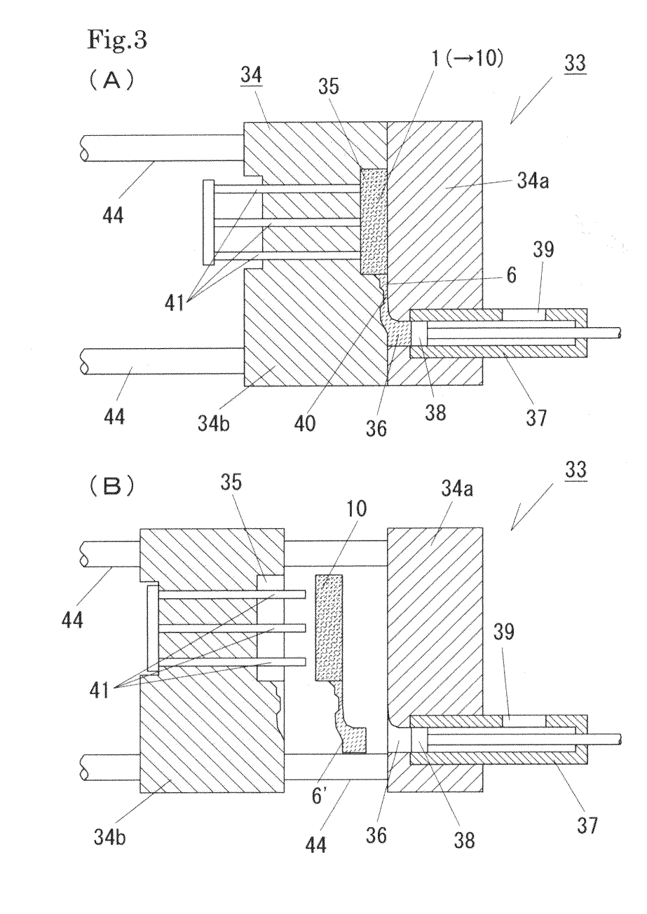

The preform 1 that is formed by the preform forming step is then subjected to the melt impregnation step with use of a die casting device 33 (see FIGS. 2 and 3) to form a metal composite material 10 that has the preform 1 in which a melt 6 of an aluminum alloy is impregnated. The metal composite material 10 that is formed in the melt impregnation step is then subjected to a surface cutting operation in which a surface of the metal composite material is polished into desired shape and dimension, whereby the metal composite material 10 that has the desired shape and dimension is obtained.

Incidentally, the above preform forming step, melt impregnation step and polishing step constitute the metal composite material production process of the present invention.

Each of the above steps for producing the metal composite material 10 according to the present examples are described below in order.

In the mixing step of the preform forming step, the following materials (i) to (iv) can be added to water that is contained in a vessel 21 and are mixed as shown in FIG. 1(A)):

(i) Alumina short fibers 2 (average fiber diameter: 3 μm, average fiber length: 400 μm)
(ii) Particles of hydrated aluminum hydroxide oxide 3 (average particle diameter: 10 μm)
(iii) Alumina sol 4 (hydrogen ion concentration pH: 3, aqueous colloidal liquid with a concentration of about 30%)
(iv) Polyacrylamide 5 (aqueous solution with a concentration of about 10%)
Here, the average fiber diameter, average fiber length and average particle diameter are average values of the fiber diameters, fiber lengths and particle diameters, respectively, with certain variations. The alumina short fibers 2 serve as a reinforcing material and the alumina sol 4 serves as an inorganic binder. The polyacrylamide 5 is so called a flocculant and serves to stably bind respective materials.

In the present example, the amount of the alumina short fibers 2 is adjusted so that the volume fraction thereof is 5% by volume or more and 15% by volume or less based on the volume of the preliminary mixture body 9 that is formed in the dewatering step and drying step, which are described hereinafter. Similarly, the amount of the hydrated aluminum hydroxide oxide particles 3 is adjusted so that the volume fraction thereof is 8% by volume or more and 12% by volume or less based on the volume of the preliminary mixture body 9. The alumina sol 4 is added in an amount so that the weight ratio thereof to a total weight of the alumina short fibers 2 and the hydrated aluminum hydroxide oxide particles 3 is about 0.05 to 0.10.

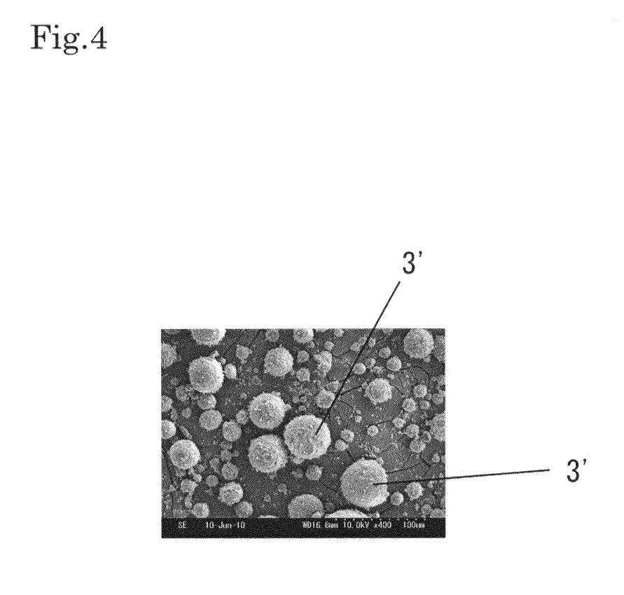

FIG. 4 shows a magnification photograph of aluminum hydroxide oxide particles 3′. The aluminum hydroxide oxide particles 3′ have fine pores with an average particle diameter of 1 nm or more and 40 nm or less. The above-described hydrated aluminum hydroxide oxide particles 3 have a crystal structure in which water of crystallization is bound to the aluminum hydroxide oxide particles 3′. Namely, the hydrated aluminum hydroxide oxide particles 3 has water of crystallization which is bound within the fine pores of the aluminum hydroxide oxide particles 3′. The average particle diameter of the fine pores to which the water of crystallization is bound is 1 nm or more and 40 nm or less. By heating the hydrate 3 at a predetermined temperature, porous aluminum hydroxide oxide particles 3′ in which the water of crystallization has been removed and which retain the fine pores with the above average pore diameter can be obtained.

In the mixing step, the aqueous liquid containing the above-described materials (i) to (iv) is stirred with a stirring rod 31 to obtain an aqueous mixture liquid 8 in which the above materials are nearly uniformly mixed. Incidentally, in the aqueous mixture liquid 8, the alumina sol 4 that is an inorganic binder deposits on the alumina short fibers 2 and the hydrated aluminum hydroxide oxide particles 3 but does not cover the hydrated aluminum hydroxide oxide particles 3.

The aqueous mixture liquid 8 is then transferred to a suction forming apparatus 22 to perform a dewatering step as shown in FIG. 1(B). The suction forming apparatus 22 includes a cylindrical inflow tank 26 to which the aqueous mixture liquid 8 is fed, a water absorbing tank 27 that is in liquid communication with a lower region 26b of the inflow tank 26, and a vacuum pump 23 that suctions water from the inflow tank 26 through the water absorbing tank 27. A filter 24 is disposed in the inflow tank 26 to divide the inside space thereof into an upper region 26a and the lower region 26b. The aqueous mixture liquid 8 is supplied to the upper region 26a that is defined above the filter 24.

In the dewatering step, after the aqueous mixture liquid 8 has been supplied to the upper region 26a of the inflow tank 26, the vacuum pump 23 is driven to suction water of the aqueous mixture liquid 8 in the inflow tank 26 through the water absorbing tank 27. Namely, the aqueous mixture liquid 8 is suctioned by the vacuum pump 23 and filtered by the filter 24. Thus, the water of the aqueous mixture liquid 8 passes through the filter 24 and enters the water absorbing tank 27 through the lower region 26b of the inflow tank 26. As a result, each of the materials in the aqueous mixture liquid 8 retains in the upper region 26a of the inflow tank 26 to form a preliminary mixture body 9 in the form of a cylinder.

Here, since the preliminary mixture body 9 after the dewatering step is obtained from the aqueous mixture liquid 8 in which respective materials are nearly uniformly dispersed in the mixing step, these materials are also present in a nearly uniformly dispersed state in the preliminary mixture body 9. Namely, the hydrated aluminum hydroxide oxide particles 3 are also nearly uniformly dispersed throughout the preliminary mixture body 9. Since the alumina sol 4 as an inorganic binder is mixed into the preliminary mixture body 9, the neighboring alumina short fibers 2 and the hydrated aluminum hydroxide oxide particles 3 are bonded with the alumina sol 4. Therefore, the cylindrical preliminary mixture body 9 is prevented from deforming or being broken during the transference to the succeeding sintering step. Namely, the structure of the cylindrical preliminary mixture body 9 can be maintained unchanged. Further, because the alumina sol 4 is admixed in a suitable amount, the interstices between the alumina short fibers 2 and the hydrated aluminum hydroxide oxide particles 3 can be maintained in relatively wide.

After the dewatering step, the preliminary mixture body 9 is taken out of the inflow tank 26 of the suction forming apparatus 22 and placed in a drying furnace at about 100° C. to perform a drying step for sufficiently remove water therefrom (not shown).

Next, the sintering step (FIG. 1(C)) is conducted. The preliminary mixture body 9 is placed on a table 29 that is disposed within a heating furnace 28 and is maintained at a sintering temperature of 1,100° C. to 1,250° C. for about 10 minutes. When the preliminary mixture body 9 is heated at such a sintering temperature, water of crystallization that is bound in the fine pores of the hydrated aluminum hydroxide oxide particles 3 that constitute the preliminary mixture body 9 is removed therefrom with the fine pores thereof retaining in the porous state that has an average pore diameter of 1 nm or more and 40 nm or less. In this manner, aluminum hydroxide oxide particles 3′ with fine pores that are retained to have an average pore diameter of 1 nm or more and 40 nm or less are obtained.

By the above sintering step, a preform 1 in the form of a cylinder in which the aluminum hydroxide oxide particles 3′ and the alumina short fibers 2 have been sintered is obtained. In the preform 1, neighboring aluminum hydroxide oxide particles 3′ and alumina short fibers 2 are relatively tightly bonded to each other as a result of crystallization of alumina particles that are contained in the alumina sol that deposits on surfaces of the alumina short fibers 2 and the aluminum hydroxide oxide particles 3′. As described previously, however, since the alumina sol 4 does not cover the aluminum hydroxide oxide particles 3′, the fine pores of the aluminum hydroxide oxide particles 3′ remain in an open state.

In the preform 1, the alumina short fibers 2 and the aluminum hydroxide oxide particles 3′ are dispersed nearly uniformly throughout the whole body thereof. Further, the preform 1, which is obtained by sintering the preliminary mixture body 9 in which interstices between the alumina short fibers 2 and the hydrated aluminum hydroxide oxide particles 3 are maintained in relatively wide, has excellent air permeability because the wide interstices are retained.

The preform 1 is then composited with an aluminum alloy in a melt impregnation step with use of a die cast forming apparatus 33 that is shown in FIGS. 2 and 3 to form a metal composite material 10. As shown in FIG. 2, the die cast forming apparatus 33 has a die assembly 34 that is constituted of a stationary die 34a and a movable die 34b. The movable die 34b is movable along guide shafts 44 between an open position (see FIG. 2(A)) and a closed position (see FIG. 2(B)). In the closed position, a cylindrical cavity 35 is defined. The stationary die 34a has a lower portion to which a sleeve 37 is connected. The sleeve 37 is provided with a gate 36 at its end portion. A plunger tip 38 is disposed in the sleeve 37 for advance and retracting movement therewithin. The sleeve 37 has an upper portion that is provided with a feed port 39 from which a melt 6 is fed to the sleeve 37.

The movable die 34b is provided with ejection pins 41 that are displaceable between retracted positions (see FIG. 2) in which the tip ends thereof lie in a plane that is coplanar with an inner wall that constitutes the cavity 35 and protruded positions (see FIG. 3(B)) in which they protrude into the cavity 35. Incidentally, the operations for displacing the ejection pins 41, for opening and closing the movable die 34b and for advancing and retracting the plunger tip 38 are controlled by a controlling device (not shown). Further, the die cast forming apparatus 33 is provided with a dipper 42 (see FIG. 2(B)) that is adapted to pour a predetermined amount of the melt 6 into the sleeve 37. The operation of the dipper 42 is also controlled by the controlling device (not shown).

In the present example, an aluminum alloy ADC12 (JIS standard) is used. The preform 1 is impregnated with the melt 6 of the aluminum alloy with use of the die cast forming apparatus 33.

The melt impregnation step which employs the die cast forming apparatus 33 is carried out in the following order. First, the preform 1 is preheated to about 500° C. and the mold assembly 34 is held at about 100° C. While maintaining the movable die 34b in the open position as shown in FIG. 2(A), the preheated preform 1 is disposed in a plenum region that is to define the cavity 35. Then, as shown in FIG. 2(B), the movable die 34b is displaced to the closed position to define the cavity 35, so that the preform 1 is accommodated in the cavity 35. When the movable die 34b is in the closed position, a runner 40, through which the cavity 35 is in fluid communication with the gate 36, is defined.

While maintaining the plunger tip 38 in the retracted position that is located rearward of the feed port 39 of the sleeve 37, a predetermined amount of the melt 6 of the aluminum alloy that is maintained at about 680° C. is poured from the feed port 39 in the sleeve 37. Thereafter, as shown in FIG. 3(A), the plunger tip 38 is driven and displaced at a predetermined speed from the retracted position, so that the melt 6 in the sleeve 37 is injected into the cavity 35 through the gate 36 and the runner 40. Thus, the preform 1 that is placed within the cavity 35 is impregnated with the melt 6. Incidentally, since the runner 40 is so designed as to have a cross-sectional area that is smaller than that of the sleeve 37 or the gate 36, the injection rate of the melt 6 that is injected into the cavity 35 is controlled to be relatively higher than the driving speed of the plunger tip 38. In particular, in the present example, the driving speed of the plunger tip 38 is 2 m/s, while the injection rate is 30 m/s. The impregnation pressure is adjusted at about 300 atm.

Since the preform 1 has excellent air permeability as described previously, the melt 6 is relatively easily impregnated thereinto. Further, although the fine pores of the aluminum hydroxide oxide particles 3′ that constitute the preform 1 are in an open state, the melt 6 does not infiltrate into the fine pores, because the average pore diameter of the fine pores of the aluminum hydroxide oxide particles 3′ is so small, namely 2 nm to 40 nm, that the melt 6 cannot enter the fine pores. Therefore, the porous state of the aluminum hydroxide oxide particles is retained.

When the melt 6 is charged in the cavity 35, the plunger tip 38 is stopped moving to stop the injection of the melt 6. After cooling, the movable die 34b is displaced to the open position as shown in FIG. 3(B). The ejection pins 41 of the movable die 34b are then displaced from the retracted positions (see FIG. 2) to the protruded positions to separate the metal composite material 10 from the movable die 34b. The metal composite material 10 thus formed by the melt impregnation step is the composite material according to the present examples.

The metal composite material 10 that is formed in the above melt impregnation step is then subjected to cutting work with use of a milling machine. In the cutting work, those portions of the composite material which correspond to the gate 36 and runner 39 (see FIG. 3(B)) are cut away to obtain the desired cylindrical form. Further, an outer peripheral surface of the metal composite material 10 is cut for mechanically polishing the outer peripheral surface (not shown) so that the metal composite material is trimmed to have the desired dimension and shape. Namely, the cutting work by the milling machine constitutes the polishing step of the process of the present invention.

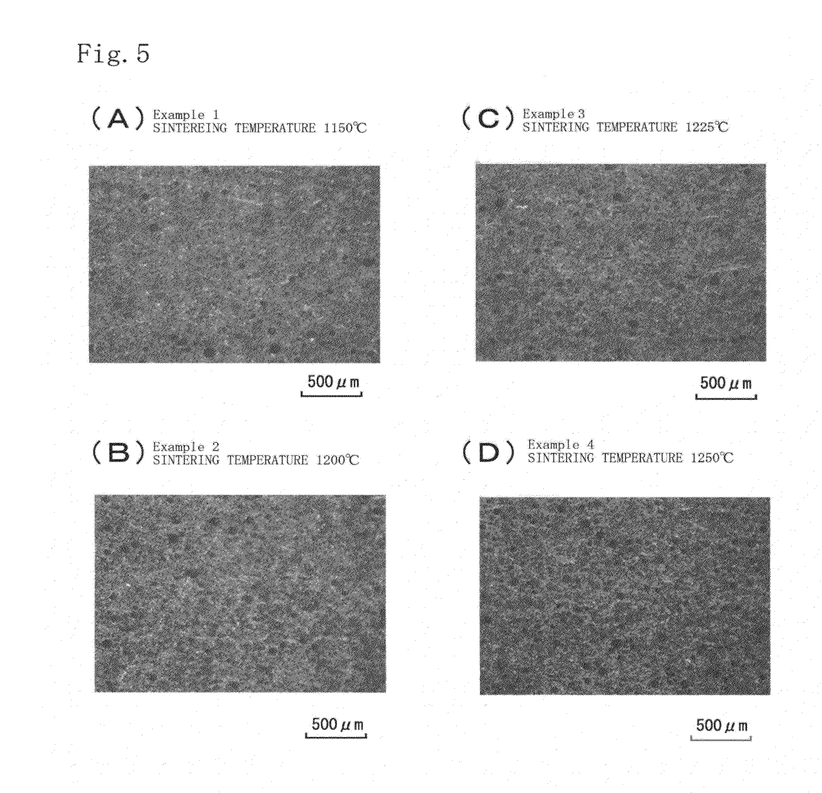

By the observation of the outer peripheral surface of the thus obtained metal composite material 10, it is confirmed that the aluminum hydroxide oxide particles 3′ are exposed thereon with their fine pores being retained (see FIG. 5). Namely, the aluminum alloy 6′ does not infiltrate into the fine pores of the aluminum hydroxide oxide particles 3′. The porous state of the particles is retained. Since the aluminum hydroxide oxide particles 3′ have fine pores with an average pore diameter of 1 nm or more and 40 nm or less, the melt cannot infiltrate into the fine pores. As a consequence, the aluminum hydroxide oxide particles 3′ are dispersed in the metal composite particles with the porous state being retained. The aluminum hydroxide oxide particles 3′ in which the porous state is retained are exposed on the outer peripheral surface.

In the metal composite material 10 of the present example, cavities (unimpregnated regions) are not formed, because the aluminum alloy 6′ is fully impregnated in the preform. Further, no cracks or flaws are formed in the metal composite material 10. It is, therefore, understood that the preform 1 has not only excellent air permeability but also a strength that is sufficient to withstand the melt impregnation pressure.

In the present example, the desired metal composite material 10 is obtained by polishing the outer peripheral surface of the cylindrical body. The outer peripheral surface represents the “surface” according to the present example.

Description is next made of the results of evaluation tests that were carried out on the metal composite material 10 of the above example. The aluminum hydroxide oxide particles that constitute the metal composite material 10 are measured for the average pore diameter and pore volume of their fine pores. The aluminum hydroxide oxide particles are formed by heating hydrated aluminum hydroxide oxide particles 3, to which water of crystallization is bound, at a predetermined temperature for the removal of the crystal water. In the present Examples, the hydrated aluminum hydroxide oxide particles 3 were heated at different temperatures of 1,150° C., 1,200° C., 1225° C. and 1,250° C. to obtain different aluminum hydroxide oxide particles.

The average pore diameter and pore volume are measured according to JIS Z8831-2 that specifies “method for measuring properties and pore size distribution of mesopores of powder (solid) by gas adsorption”. Details of the measuring method are omitted here. In the present Examples, the measurement is performed by using nitrogen gas.

The aluminum hydroxide oxide particles formed by heating the hydrated aluminum hydroxide oxide particles 3 at 1,150° C. were found to have an average particle diameter of 6 nm and a pore volume of 0.35 cc/g. The aluminum hydroxide oxide particles formed by heating at 1,200° C. were found to have an average particle diameter of 11 nm and a pore volume of 0.25 cc/g. The aluminum hydroxide oxide particles formed by heating at 1,225° C. were found to have an average particle diameter of 15 nm and a pore volume of 0.22 cc/g. The aluminum hydroxide oxide particles formed by heating at 1,250° C. were found to have an average particle diameter of 30 nm and a pore volume of 0.16 cc/g. It was also confirmed that, in any of these types of aluminum hydroxide oxide particles, the water of crystallization was removed and the average pore diameter was retained in the range of 1 nm or more and 40 nm or less.

With use of the hydrated aluminum hydroxide oxide particles 3, metal composite materials 10 were produced by performing the above-described preform forming step, melt impregnation step and polishing step. Here, the sintering step was carried out at sintering temperatures of 1,150° C., 1,200° C., 1225° C. and 1,250° C. to obtain different metal composite materials 10. Thus, the metal composite material 10 obtained at a sintering temperature of 1,150° C. is Example 1, the metal composite material 10 obtained at a sintering temperature of 1,200° C. is Example 2, the metal composite material 10 obtained at a sintering temperature of 1,225° C. is Example 3, the metal composite material 10 obtained at a sintering temperature of 1,250° C. is Example 4. FIG. 5 shows magnification photographs of the metal composite materials of Examples 1 to 4, respectively, each in a color checking state. The surface of each of the metal composite materials 10 is in a state in which it was first applied with “Color Check Liquid” of a flaw detection agent, thereafter wiped and then washed with water. It is seen that in the composite materials of Example 1 (FIG. 5(A)) that employs a sintering temperature of 1,150° C., Example 2 (FIG. 5(B)) that employs a sintering temperature of 1,200° C. and Example 3 (FIG. 5(C)) that employs a sintering temperature of 1,225° C., portions that are colored with the Color Check Liquid tend to increase as the sintering temperature increases. However, in the composite material of Example 4 (FIG. 5(D)) that employs a sintering temperature of 1,250° C., portions that are colored with the Color Check Liquid decrease as compared with those of Example 3 (1,225° C.). It is considered that the amount of an oil, that is held in the aluminum hydroxide oxide particles which are exposed on the surface, increases with an increase of the colored portions.

The metal composite materials 10 of Examples 1 to 4 were further tested for the measurement of their oil retaining property. From the outer peripheral surface of each of the metal composite materials, a rectangular test piece with a dimension of 30 mm×80 mm was cut out. An automobile engine oil (lubricating oil) was applied to the outer peripheral surface of each of the test pieces. A weight increase of each of the test pieces before and after the application of the oil was measured. In this case, after the engine oil had been applied, the test piece was allowed to stand for 10 minutes and, thereafter, the outer peripheral surface was wiped with a cloth. Such a wiping operation was repeated until the measured weight was stabilized. The weight increase that is obtained from the stabilized weight represents the amount of retained oil from which the oil retaining property is evaluated. In the present Examples, the amount of the retained oil is expressed in terms of amount of the oil that is retained per unit area.

For the purpose of comparative study of the oil retaining property, a metal composite material of Comparative Example 1 that contained aluminum borate particles; and a composite material of Comparative Example 2 that contained zeolite particles were measured for their oil retaining property in the same manner as above. The metal composite material of Comparative Example 1 was prepared in such a manner that aluminum borate particles were used in lieu of the hydrated aluminum hydroxide oxide particles in the mixing step of the above preform forming stage and a sintering temperature of 1,200° C. was used in the sintering step. The aluminum borate particles had an average pore diameter of 100 nm and a pore volume of 0.14 cc/g. The metal composite material of Comparative Example 2, on the other hand, was prepared in such a manner that zeolite particles were used in lieu of the hydrated aluminum hydroxide oxide particles in the mixing step of the above preform forming stage and a sintering temperature of 1,200° C. was used in the sintering step. The zeolite particles had an average pore diameter of 0.5 nm and a pore volume of 0.1 cc/g. Except for these points, the metal composite materials of Comparative Examples 1 and 2 were prepared by the same production steps as those in the above Examples.

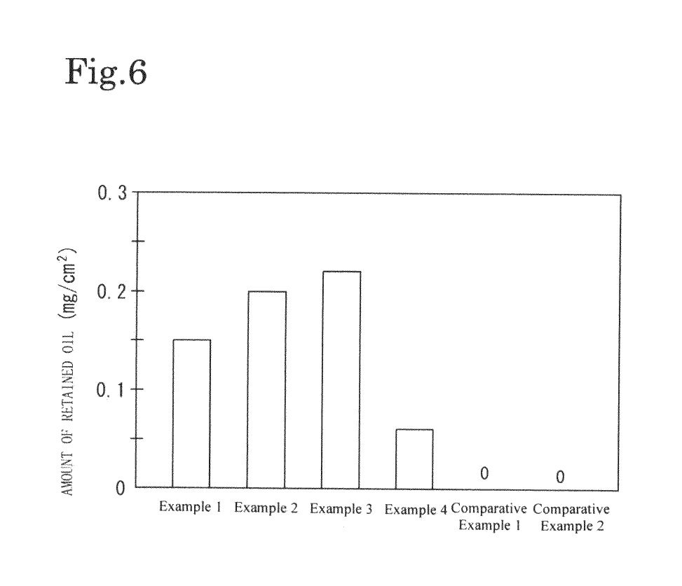

The results of the oil retaining property measurement for the metal composite materials 10 of Examples 1 to 4 and the metal composite materials of Comparative Examples 1 and 2 are shown in FIG. 6. From the results, it is apparent that the metal composite materials 10 of Examples 1 to 4 have oil retaining property. It can be said that such oil retaining property is obtained because fine pores are retained in the aluminum hydroxide oxide particles that are exposed on the outer peripheral surface of the metal composite materials 10 of Examples 1 to 4. Especially high oil retaining property is exerted in the metal composite material 10 of Example 3 that is produced with use of a sintering temperature of 1,225° C. Comparison of the metal composite materials 10 of Examples 1 to 4 indicates that the results of the oil retaining property measurement show similar tendency to the results of the color checking state (see FIG. 5). From these results, it is apparent that the oil retaining property is exerted by the fine pores of the aluminum hydroxide oxide particles that are exposed on the outer peripheral surface of the metal composite material.

Each of the metal composite materials of Comparative Examples 1 and 2, on the other hand, scarcely shows oil retaining property. In the case of Comparative Example 1, since the aluminum borate particles have an average pore diameter of 100 nm, the melt infiltrates into the pores of the aluminum borate particles during the melt impregnation step. Therefore, the engine oil cannot infiltrate into the pores and the composite material has no oil retaining property. In the case of Comparative Example 2, since the zeolite particles have an average pore diameter of 0.5 nm, the melt cannot infiltrate into the pores of thereof during the melt impregnation step. Therefore, the porous state is retained in the zeolite particles. However, the average pore diameter is so small that the engine oil cannot enter the pores of the zeolite particles. Accordingly, the composite material has no oil retaining property.

Thus, since the metal composite material 10 of the present example has high oil retaining property, it can exert high wear resistance when applied to a sliding member such as a cylinder or a piston. Namely, when a desired sliding member is formed in the same manner as that for the formation of the metal composite material 10 of the present example and when the obtained sliding member is polished in the same manner as that for the outer peripheral surface to form a sliding surface, the aluminum hydroxide oxide particles that retain their porous state are exposed on the sliding surface.

When sliding members, for example, a cylinder and a piston of an engine are formed of the metal composite material 10 of the present example, such sliding members perform sliding movement in an engine oil. Therefore, the engine oil is absorbed and retained in the fine pores of the aluminum hydroxide oxide particles that are exposed on their sliding surfaces. As the sliding movement is repeated, the engine oil that is retained in the fine pores of the aluminum hydroxide oxide particles oozes therefrom. Therefore, even when the lubricating oil that are present between the sliding members gradually deteriorates upon repeated sliding movement, wear of the sliding members can be suppressed and the sliding life can be generally prolonged, because the engine oil oozes from the fine pores of the aluminum hydroxide oxide particles.

In the manner as described above, the cylinder and piston that are formed of the metal composite material of the present example have prolonged sliding life through which the desired wear resistance is maintained and have significantly improved durability.

Since, in the metal composite material according to the present example, the aluminum hydroxide oxide particles have fine pores with an average pore diameter of is 1 nm or more and 40 nm or less, all of the aluminum hydroxide oxide particles that constitute the metal composite material retain the porous state. Therefore, all of the aluminum hydroxide oxide particles that are exposed as a result of surface polishing in the polishing step retain their fine pores. Namely, it is possible to produce in a stable manner a metal composite material that can stably exert oil retaining property. It is also possible to stably provide a high quality sliding member such as a cylinder by employing the metal composite material. Incidentally, similar operation and effect may be obtained even when porous ceramic particles that have fine pores with an average pore diameter of 1 nm or more and 40 nm or less and that are other than the aluminum hydroxide oxide particles are used. Further, it is also expected that similar operation and effect may be obtained even when porous ceramic particles that have fine pores with an average pore diameter of 1 nm or more and 80 nm or less are employed.

Although an alumina sol is used as an inorganic binder in the mixing step of the above-described example, a silica sol may be used in place of the alumina sol. Further, although, in the above-described example, hydrated aluminum hydroxide oxide particles are admixed in the mixing step and the water of crystallization is removed in the sintering step, it is possible to admix, in the mixing step, aluminum hydroxide oxide particles that have been previously obtained by heating hydrated aluminum hydroxide oxide particles at a predetermined temperature.

It should be noted that the present invention is not limited only to the above example but may be embodied appropriately in other specific forms within the scope of the gist of the above.

What is claimed is:

1. A process for producing a metal composite material, comprising:
a mixing step, mixing, in water, hydrated ceramic particles, which have water of crystallization that is bound within fine pores thereof that have an average pore diameter of 1 nm or more and 80 nm or less, with a reinforcing material to prepare an aqueous mixture liquid,
a dewatering step, removing water from the aqueous mixture liquid to form a preliminary mixture body,
a sintering step, sintering the preliminary mixture body to form a preform in which the ceramic particles and the reinforcing material are present in a mixed state,
a melt impregnation step impregnating the preform with a melt of an aluminum alloy, under pressure, to form a composite material, and
a polishing step polishing a predetermined surface of the composite material that has been formed in the melt impregnation step.

2. The process according to claim 1, wherein the ceramic particles are aluminum hydroxide oxide particles.

3. The process according to claim 2, wherein a sintering temperature in the sintering step is 1,100° C. or more and 1,250° C. or less.

4. The process according to claim 1, wherein the ceramic particles have fine pores with an average pore diameter of 1 nm or more and 40 nm or less.
